(19) United States
(12) Patent Application Publication
(10) Pub. No.: US 2020/0318427 A1
(43) Pub. Date: Oct. 8, 2020

(54) TRANSOM BLIND ACCESSORY FOR VENETIAN BLINDS AND BLINDS FORMED WITH A TRANSOM

(71) Applicant: William Alex Simms, Centerville, OH (US)

(72) Inventor: William Alex Simms, Centerville, OH (US)

(21) Appl. No.: 16/385,028

(22) Filed: Apr. 16, 2019

Related U.S. Application Data
(60) Provisional application No. 62/830,808, filed on Apr. 8, 2019.

(51) Int. Cl. E06B 9/264; E06B 9/303

(52) U.S. Cl. CPC E06B 9/264; E06B 9/303

(57) ABSTRACT

A transom blind accessory for a window pocket for receiving one or more blind includes a covering member between upper and lower blinds.

### FIELD OF THE INVENTION

This invention relates generally to a venetian blind. More particularly, but not by way of limitation, the invention relates to a transom blind accessory which is adapted to hold one or more elongated members of a bottom and optionally a top of adjacent venetian blinds which acts to separate two sets of blinds in a way which one set can remain open while the other can be closed creating a selectively amount of light into the room as desired. The invention also relates to a venetian blind formed with a transom.

### BACKGROUND OF THE INVENTION

A venetian blind typically has a headrail or channel which is mounted along the upper side of a window casing and has a plurality of horizontal slats which are suspended in a vertically spaced relationship below the headrail by string or tape ladders and there is provided a bottom rail which includes rail caps and bottom rail buttons to terminate and retain the terminal end of the ladders. The headrail contains a mechanism which provides for raising or lowering and tilting of the slats. In some applications, a valence is provided to hide the headrail for aesthetic reasons.

There is a desire to improve existing venetian blinds. The instant invention provides a significant improvement and accessory to venetian blinds.

### SUMMARY OF THE INVENTION

Accordingly, an object of the present invention is to improve venetian blinds.

Another object is provide a transom blind accessory for venetian blinds.

Still a further object is to provide a transom blind accessory for receiving at least a bottom rail of an upper mounted venetian blind and optionally a headrail of lower mounted blind to conceal both the bottom rail the headrail and to provide an aesthetically pleasing effect whereby a transom is formed permitting a user to selectively open the upper or lower blind.

A further object of the present invention is to provide a transom blind accessory which is easy to install on existing blinds.

Yet another object of the present invention is to provide a transom blind accessory which is simple and inexpensive to manufacture.

One other object is to provide a unique venetian blind which includes and separate upper and lower selectable openable/closable sections.

Still another object is to provide a transom blind accessory with an aesthetic interchangeable face.

The objects and purposes of the invention, including those set forth above, are met by providing at least one elongate covering member separating an upper blind and a lower blind thereby providing a transom effect between the two blinds. In one embodiment, the covering member can include a generally U-shaped cross section for receiving a bottom rail of the blind. In another embodiment, the covering member can include a generally H-shaped cross-section for receiving a bottom rail of the upper blind and a head rail of the lower blind. In yet another embodiment, the covering member can be an integral part of a blind which separates the upper blind and lower blind and houses a mechanism to permit separate operability of opening and closing the upper and lower blinds.

It is contemplated that in the embodiments wherein the covering member is not an integral component, but a separate accessory, that there can be provided inwardly extending detents on one or more an inner wall surface to aid in retaining the bottom rail or head rail. Another aspect is that the side wall of transom accessory can be contoured or receives a printed indicia for one's enjoyment or advertising. Further, it is contemplated that one or more wall surface of the covering member can be selectable actuated to a desired width to provide a desired fit about the respective bottom rail or head rail.

### BRIEF DESCRIPTION OF THE DRAWINGS

Other objects, purposes and advantages of this invention will be apparent to persons acquainted with apparatus of this general type upon reading the following description and inspecting the accompanying drawings, in which:

FIG. 1 is a perspective view of one exemplary embodiment of the invention.

FIG. 2 a plan view of an embodiment of the invention.

FIG. 3 is a cross section view through line A-A in FIG. 2.

FIG. 4 is an end view of a transom accessory of the invention.

FIG. 5 is an end view of another embodiment of the transom accessory of the invention.

FIG. 6 is another embodiment of the transom accessory of the invention.

FIG. 7 is a perspective view of a part of the invention.

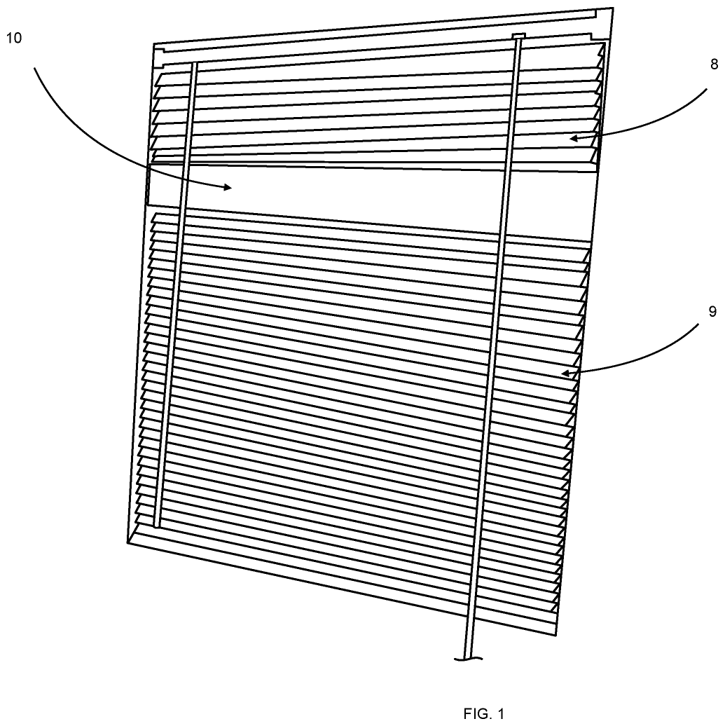

### DETAILED DESCRIPTION OF PREFERRED EMBODIMENTS

Referring now to the drawings, a transom blind accessory or covering member is generally referred to by the numeral 10 (and as seen in the drawings in various embodiments as 60, 600 and 700). The transom blind accessory 10 can be configured for use with a conventional venetian blind 8 or 9 as will be apparent hereinafter. Like parts will be reflected with like numerals.

In one embodiment, the venetian blind 8 will include a headrail 12 which is commonly an inverted U-shaped channel having an upper wall 14, and two downward extending side walls 16 and 18. An operating mechanism 20 is operably mounted on the upper wall 14 within the headrail 12 and connected to this is a ladder 22 (string to tape, for example) which suspends a plurality of horizontal blind slats 24 from the headrail 12. A bottom rail 26 serves as the lower slat and includes button holes (not shown) through which pull strings 28 extend and are held in fixed position thereto by buttons (not shown) which insert into the button holes (not shown) on the bottom rail 26 and sandwich an end 30 of the pull string 28. Another end 32 of the pull string extends up through the ladder 22 and operating mechanism 20 and out thereof with sufficient length to enable one to grasp and pull on the same in order to raise and lower the ladder 22. A handle 34 is operably connected to a pivoting member 36 within the operating mechanism 20 wherein the rotation of the handle 34 causes the pivoting member 36 to rotate between two points in a limited manner and with the ladder 22 operably connected to the pivoting member 36 such that the rotation causes the slats 24 to move from an open to closed position. In this regard, the ladder 22 is operably connected to the operating mechanism 20 to enable actuation of the ladder 22 and in turn the slats 24 by pull strings 28 and/or handle 34.

For one embodiment, the blind 9 is similarly formed to that of blind 8 but as will be apparent, the handle 28, ladder 22 length and number of slats 24 can vary. The blinds 8 and 9 are deposed in a window pocket, having side walls 50 of a height H, top wall 52 and bottom wall 54, of a width W and all of which have a depth D. The blinds 8, 9 are of a width W1=W−Δx spanning substantially between the walls (50). The headrail (12) has a height H1, width W1 and a depth D1=D−Δy, a ladder (22) (which are strings or tape, for example), slats (24) having a height H2=H1−Δa and a depth D2=D1−Δz and bottom rail (26) having a height H3=H1−Δb and a depth D3=D1−Δz′.

In this illustrated embodiment, a fewer number of slats 24 and shorter ladder 22 and handle 34 length are preferred for upper blind 8 than lower blind 9 which is depicted in a window pocket for receiving blinds 8, 9. The headrail 12 of blind 8 will be mounted in a conventional manner adjacent the top wall 52. Preferably, the headrail 12 of the blind 9 will be mounted more than half way up the side walls 50 in a horizontal manner. The ladder 22 length of blind 8 will preferably be sufficient such that bottom rail 26 will rest adjacent the top of headrail 12 of blind 9 and ladder 22 length of blind 9 will be such that bottom rail 26 will rest adjacent the bottom wall 54.

In another embodiment, at least one elongate covering member 60 is provided to cover the bottom rail 26 of upper blind 8 and be disposed adjacent the head rail 12 of lower blind 9 thereby providing a transom effect between the two blinds 8 and 9. In this embodiment, the covering member 60 can include a generally U-shaped cross section defining an upper channel 61 having a lower wall 62, and two upward extending side walls 64 and 68 which are configured of sufficient length and width for receiving the bottom rail 26 of the blind 8 and optionally one or more slats 24. The lower wall 62 is preferably configured, flat for example, to lay on top of headrail 12 of blind 9 so that substantially no light passes there between. The generally U-shaped cross section is formed with the lower wall (62) of a depth D3+Δm, and two upward extending side walls (64, 68) and having a height of at least H3+Δn which is provides for the covering member 60 covering at least the bottom rail 26 and preferable one or more slat 24.

In another embodiment, the covering member 600 can include a generally H-shaped cross-section defining upper channel 670 and lower channel 672 having a cross-section wall 662, and two extending side walls 664 and 668 which are configured of sufficient length and width for receiving the bottom rail 26 of the upper blind 8 and optionally one or more slats 24 in an upper channel 670 of the covering member 600 and lower channel 672 for receiving the headrail 12 of the lower blind 9.

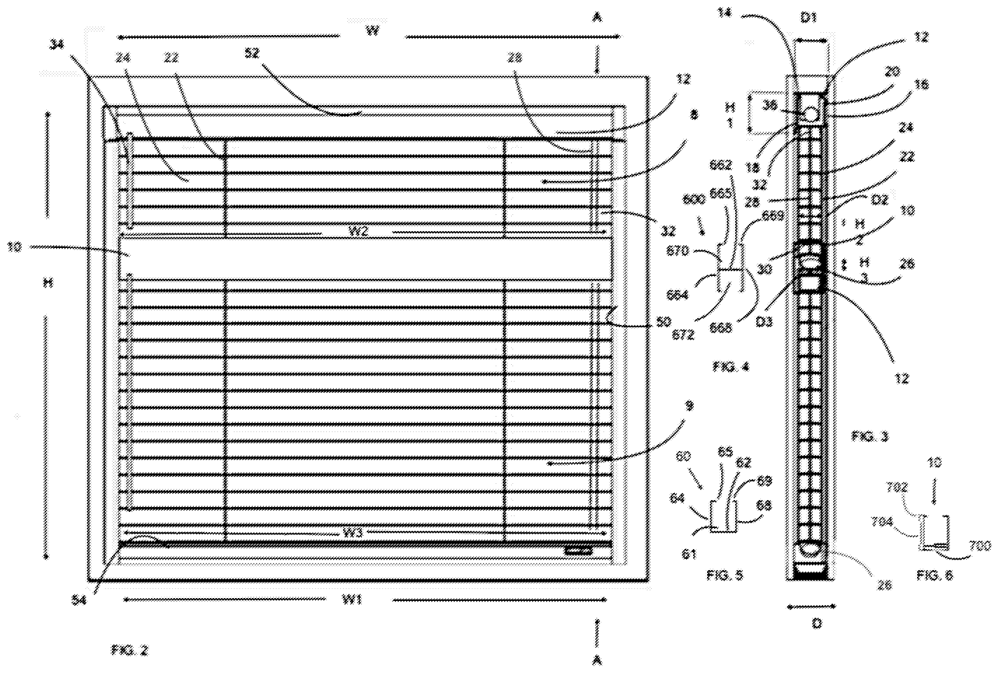

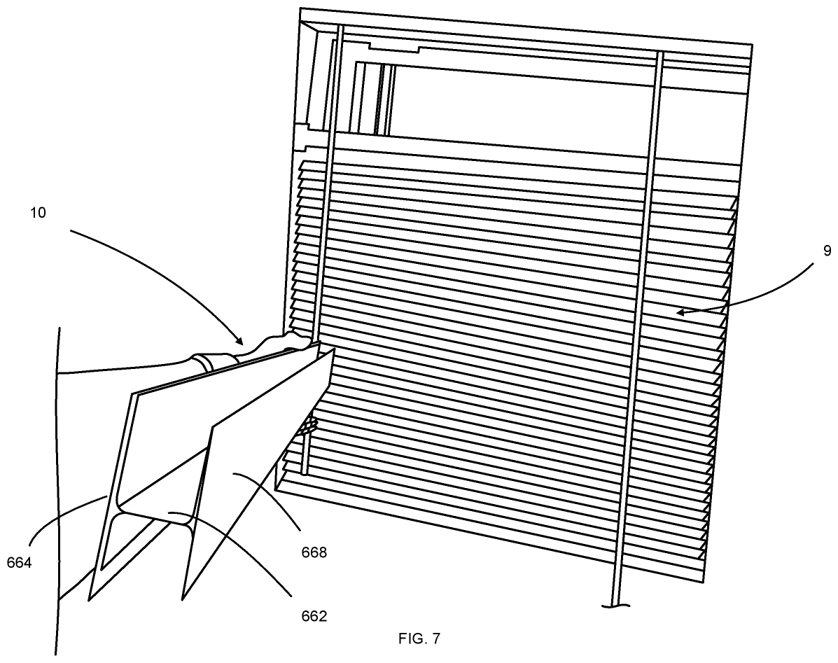

It is contemplated that the side walls 64, 68, 664 and 668 can include inwardly formed protrusions 65, 69, 665 and 669 serving as detents to aid retention of the respective part received. It is also contemplated that the side walls 64, 68, 664 and 668 can be integrally connected to their respective lower wall 62 and cross-section wall 662, respectively, or connected by other means, such as a ratchet type snap fit as seen in covering member 700, to provide for adjustability in width to accommodate various width slats and rails (see FIG. 6).

In yet another embodiment, the covering member 10 can be an integral part of a transom blind which separates an upper blind portion 8 and lower blind portion 9. In this embodiment for example, the cross section wall 662 can serve as both a bottom rail and headrail for the respective upper blind 8 and lower blind 9. In this embodiment, there there can be provided an L bracket mount or the like to secure the covering member 10 to the side walls 50.

Another aspect is that the side wall of transom accessory 10, as seen 700, for example, can be contoured or configured with a retainer element 702 which receives a printed member 704 for one's enjoyment or advertising. For example, the side walls 64, 68, 664 and 668 can be provided with a curved surface or flat and can include a printed indicia of advertising or memorabilia, such as favorite sports team. It is contemplated that the side walls 64, 68, 664 and 668 can be provided with retainer clip permitting interchangeable a side panel covering to be inserted thereto, thus enabling a color selection, or displaying an image as desired, such as a sports team logo or other advertisement.

By so providing, the invention transforms conventional venetian blind technology to enable one to have a transom effect within a single window which is aesthetically and functionally unique. It is contemplated that other modifications, derivations and variation of the invention will be apparent to those skilled in the art and that these should be afforded within the scope of the claims appended hereto.

What is claimed is:

1. A transom blind accessory for a window pocket of a height H and width W having side walls (50), top wall (52) and bottom wall (54) for receiving one or more blind of a width W−Δx spanning substantially between the walls (54), the blind having a headrail (12), a ladder (22), slats (24) and a bottom rail (26) and wherein the headrail (12) has a height H1, width W1 and a depth D1, slats (24) having a height H2, width W2 and a depth D2 and a bottom rail (26) having a height H3, width W3 and a depth D3, which includes:
at least one elongate covering member (10) spanning a width of substantially W−Δx and at least a height H3.

2. The transom blind accessory of claim 1, wherein said generally U-shaped cross section channel (61) has a lower wall (62) of a depth D3+Δm, and two upward extending side walls (64, 68) and having a height of at least H3+Δn which is provides for the covering member (60) covering at least the bottom rail (26) and preferable one or more slat 24.

3. The transom blind accessory of claim 1, wherein said lower wall (62) is configured in a complementary manner to rest on a head rail (12) of a lower mounted blind (9).

4. The transom blind accessory of claim 3, wherein said covering member (60) substantially prevents light from pass by said headrail (12) and said lower wall (62).

5. The transom blind accessory of claim 2, wherein said side walls (64, 68) include inwardly formed protrusions (65, 69) serving as detents to aid retention.

6. The transom blind accessory of claim 2, wherein said side walls (64, 68) adjustably connect to lower wall (62).

7. The transom blind accessory of claim 1, wherein said covering member (10) is configured for displaying an interchangeable panel.

8. A transom blind accessory for a window pocket of a height H and width W having side walls (50), top wall (52) and bottom wall (54) for receiving an upper blind (8) and a lower blind (9), each blind (8,9) of a width W−Δx spanning substantially between the walls (54), the blind having a headrail (12), a ladder (22), slats (24) and a bottom rail (26) and wherein the headrail (12) has a height H1, width W1 and a depth D1, slats (24) having a height H2, width W2 and a depth D2 and a bottom rail (26) having a height H3, width W3 and a depth D3, which includes:
a covering member (600) having a generally H-shaped cross-section cross section defining an upper channel (670) and a lower channel (672) having a cross-section wall (662), and two extending side walls (664, 668) interconnected by said cross-section wall 662 which are configured of sufficient length and width for receiving at least the bottom rail (26) of the upper blind (8) in an upper channel (670) of the covering member (600) and said lower channel (672) for receiving the headrail (26) of a lower blind (9).

9. The transom blind accessory of claim 8, wherein said a cross-section wall (662) has a depth D3+Δm, and said side walls (664, 668) and have a height of at least H1+H3.

10. The transom blind accessory of claim 8, wherein said cross-section wall (662) is configured to rest on a head rail (12) of a lower mounted blind (9).

11. The transom blind accessory of claim 9, wherein said side walls (664, 668) adjustably connect to said cross-section wall (662).

12. The transom blind accessory of claim 9, wherein said side walls (664, 668) include inwardly formed protrusions (665, 669) serving as detents to aid retention.

13. The transom blind accessory of claim 8, wherein said covering member (10) is configured for displaying an interchangeable panel.

14. A transom blind for a window pocket of a height H and width W having side walls (50), top wall (52) and bottom wall (54), which includes:
an upper blind portion (8) and a lower blind portion(9), each blind portion (8,9) of a width W−Δx spanning substantially between the walls (54), the upper blind portion (8) having a headrail (12), a ladder (22), slats (24) and wherein the headrail (12) has a height H1, width W1 and a depth D1, and slats (24) have a height H2, width W2 and a depth D2 and the lower blind portion (9) has a ladder (22), slats (24) and a bottom rail (26) wherein the slats (24) have a height H2, a width W2 and a depth D2 and a bottom rail (26) has a height H3, width W3 and a depth D3, a covering member (10) which separates said upper blind portion 8 and lower blind portion 9 to provide a transom.

15. The transom blind accessory of claim 14, wherein said covering member (10) is configured for displaying an interchangeable panel.
